(19) United States
(12) Patent Application Publication
(10) Pub. No.: US 2025/0368807 A1
(43) Pub. Date: Dec. 4, 2025

(54) ECO-FRIENDLY WATER RETENTION NATURAL POLYMER AND PRODUCTION METHOD THEREOF

(71) Applicant: EF Polymer K.K., Okinawa (JP)

(72) Inventor: Narayan Lal GURJAR, Okinawa (JP)

(73) Assignee: EF Polymer K.K., Okinawa (JP)

(21) Appl. No.: 19/299,846

(22) Filed: Aug. 14, 2025

Related U.S. Application Data
(63) Continuation-in-part of application No. 17/629,946, filed on Jan. 25, 2022.

(30) Foreign Application Priority Data
Jul. 31, 2019 (IN) 201911030835

(51) Int. Cl. C08L 5/00; B01J 20/24; C08K 5/42

(52) U.S. Cl. CPC C08L 5/00; B01J 20/24; C08K 5/42; C08L 2201/06; C08L 2312/00

(57) ABSTRACT

The present invention provides for a water retention polymer capable of retaining water for long durations and in huge amounts and the method of preparing the same. The polymer is capable of releasing the retained water slowly and as per the requirements of the crop and soil. Thus, the water retention polymer minimizes the water requirement during irrigation and other purposes. Further, the said polymer is eco-friendly, pollution free and completely biodegradable. The polymer can be used to grow plants on barren lands and marble slurry. The use of this polymer also minimizes the requirement of fertilizer for the crops. Further, the said water retention polymer is low-priced and hence affordable by farmers. The reduction in water requirement and fertilizer due to the use of this water retention polymer reduces 60% overall production cost for the farmers and hence results in more income generation from agriculture.

### RELATED APPLICATIONS

This application is a continuation-in-part of U.S. patent application Ser. No. 17/629,946, filed Jan. 25, 2022, which is a U.S. national stage application of PCT/IN2020/050679, filed Jul. 31, 2020, which claims priority to Indian patent application Ser. No. 201911030835, filed Jul. 31, 2019, the entire contents of all of which are hereby incorporated by reference.

### FIELD OF THE INVENTION

The present invention relates to a polymer and in particular relates to an eco-friendly water retention polymer. The present invention further relates to a method of preparing eco-friendly water retention polymer.

### BACKGROUND OF THE INVENTION

Every country's economy depends on agriculture to a certain extent. The agricultural sector needs huge amounts of water for irrigation and scarcity of water to the plants and crops results in reduction in cultivation and as a result 30-40% productive lands are left uncultivated.

Super Absorbent Polymers hydrogel (hereinafter, referred to as “SAP” in below), absorbent polymers, absorbent gels, super soakers, super simpers, water gel, are macromolecular synthetic water absorbing polymers.

They have a water 15 uptake potential as high as 100,000% of its own weight in a short period of time by osmosis and form granules in soil to enhance soil properties. SAPs are generally white sugar-like hygroscopic materials that swell in water to form a clear gel made of separate individual particles and can retain moisture even under pressure without risk of conflagration or rupturing/blasting.

Super Absorbent Polymers used in agriculture are mostly prepared from acrylic acids and a cross-linking agent like potassium by solution or suspension polymerization. The polymer so formed is called a polyacrylate whose swelling 5 capacity and gel modulus depends greatly on the quantity and type of cross-linker used. Polyacrylates are non-toxic, non-irritating and non-corrosive in nature and tested to be biodegradable with a degradation rate of 10%-15% per year. They demonstrate high water absorbance potential and can freely release 95% of the same under suction pressure by plant roots.

### SUMMARY OF THE INVENTION

### Problems to be Solved by the Invention

All the present water retention super absorbent polymers are created by using chemicals, so they have adverse effects on the crops, soil, soil's moisture capacity, soil fertilizer capacity, and on farmers. The existing polymers pollute soil and air and are not fully biodegradable or take too long time to degrade completely. The 15 examples of superabsorbent polymers available are Sodium Polyacrylate, Polyacrylamide Copolymer, Ethylene-Maleic Anhydride Copolymer, Polyvinyl Alcohol Copolymers etc. All of the SAPs are chemically made and not perfectly suitable for crops and soil health.

Thus, there is a long felt need for a super absorbent polymer and method thereof that is eco-friendly, completely biodegradable, has good water retention capacity and sustainability.

### Objects of the Invention

It is an object of the present invention, to provide a water retention polymer capable of retaining water for long durations.

It is another object of the present invention, to provide a water retention polymer that minimizes the water requirement in the irrigation process.

It is yet another object of the present invention, to provide a water retention polymer that is eco-friendly, pollution free and completely biodegradable.

It is yet another object of the present invention, to provide a water retention polymer that can reduce the fertilizer requirement for the crops.

It is yet another object of the present invention, to provide a water retention polymer that can be used to grow plants on barren lands and marble slurry.

It is yet another object of the present invention, to provide a water retention polymer that is low priced.

It is yet another object of the present invention, to provide a method for preparing a water retention polymer that is eco-friendly and easy to perform.

### Means for Solving the Problem

The invention provides for an eco-friendly water retention natural polymer including fully biodegradable natural polymer having water retention property to reduce the amount of water required for growing a plant by 60% to 80%, comprising nutrient components (1) to (3): (1) at least one polysaccharide selected from the group consisting of linseed gum, xanthan gum, guar gum, and tragacanth gum; (2) a polysaccharide extracted from biological waste; and (3) a cross-linker capable of cross-linking the at least one polysaccharide to the polysaccharide derived from biological waste. Additionally, in some embodiments, the cross-linking agent is a cross-linking agent other than a metal ion.

Here, the biological waste from which the pectin is extracted is preferably at least one selected from the group consisting of a fruit waste, a vegetable waste, a fig bark, and an oil cake residue. The fruit waste is preferably at least one selected from the group consisting of a citrus fruit peel, a banana peel, and a jackfruit skin. The pectin preferably contains a galacturonic acid content of above 75%, methoxy content of 9 to 15%, and degree of esterification below 50%. The pectin preferably includes galacturonic acid content of above 75%, methoxy content of 9 to 15%, and degree of esterification between below 20 to 25%. The cross-linker is preferably sulfosuccinic acid.

Also, another aspect of the present invention is a production method preparing an eco-friendly water retention natural polymer of a fully biodegradable natural polymer, the method comprising f: (A) extracting pectin from biological waste; (B) dissolving the pectin obtained in (A) in a solution including 3% to 8% of NaOH and 3% to 10% of urea by stirring at 100 to 500 rpm for 10 to 45 minutes to obtain a pectin solution; (C) adding at least one polysaccharide selected from the group consisting of linseed gum, xanthan gum, guar gum and tragacanth gum at a ratio of 1:3 to 3:1 by weight to the pectin solution by stirring for 25 to 35 minutes: (D) adding 1% to 10% of a cross-linking agent by total weight to the polymer and mixing the cross-linking agent and the pectin solution to obtain a mixture; (E) cross-linking the mixture by incubating the mixture at 55 to 90 degrees centigrade for 5 to 6 hours; (F) cooling the mixture and then drying the mixture for 15 to 24 hours at 60 to 80 degrees centigrade; and (G) grinding a polymer obtained in (E) to prepare a powder of which mesh size ranges from 60 to 150.Additionally, in some embodiments, the cross-linking agent is a cross-linking agent other than a metal ion.

The biological waste is preferably at least one selected from the group consisting of a fruit-waste, vegetable waste, fig barks and oil cake residue. Also, the fruit-waste is preferably at least one selected from the group consisting of a citrus fruit peel, a banana peel, and a jackfruit skin.

The extracting (A) further comprises: (A1) obtaining the cleaned waste by washing a fruit peel of the biological-waste with tap water, and then washing the fruit peel with redistilled water to remove physical impurities from a surface of the fruit peel; (A2) preparing the powder by drying the cleaned waste at a temperature under 60 degrees centigrade for 24 to 48 hours to obtain a dried waste, and then grinding the dried waste to be filtered with a filter having a mesh size from 60 to 80; (A3) mixing the dried powder with water at the ratio of 1:50 to prepare a mixture, adjusting pH of the mixture between 1 to 4 by using lemon juice, heating the mixture at 55 degrees centigrade for 3 hours, and then cooling the mixture, thereby separating soluble pectin from insoluble pectin; (A4) a precipitating the soluble pectin by adding equal volume of ethanol to the separated soluble pectin solution; and (A5) powdering the soluble pectin by drying the soluble pectin solution obtained in the step (A4).

The pectin has a galacturonic acid content of above 75%, methoxy content of 9 to 15%, and degree of esterification below 50%. Also, the degree of esterification is preferably 20 to 25%. The fully biodegradable polymer has water retention property to reduce the amount of water required for growing a plant by 60% to 80%.

The invention provides for a water retention polymer capable of retaining water for long durations and in huge amounts. The polymer is capable of releasing the retained water slowly and as per the requirements of the crop and soil. Thus, the water retention polymer minimizes the water requirement during irrigation and other purposes. Further, the said polymer is eco-friendly, pollution free and completely biodegradable. The invention also provides for a method for preparing water retention polymer that is easy to perform and eco-friendly. Furthermore, the polymer is eco-friendly without environmental pollution and fully biodegradable. The present invention provides a method for preparing the polymer having the water retainable property, without massive facilities and eco-friendly.

The present water retention polymer can be used to grow plants on barren lands and marble slurry. The use of this polymer also minimizes the requirement of fertilizer for the crops. Further, the said water retention polymer is low-priced and hence affordable by farmers. The reduction in water requirement and fertilizer due to the use of this water retention polymer reduces 60% overall production cost for the farmers and hence results in more income generation from agriculture.

### BRIEF DESCRIPTION OF THE DRAWINGS

For a better understanding of the embodiments of the methods described herein, and to show more clearly how they may be carried into effect, references will now be made, by way of example, to the accompanying drawings, wherein like references numerals represent like elements/components throughout and wherein:

FIG. 1 illustrates different steps of the method of preparing eco-friendly water retention natural polymer, according to an embodiment of the present invention.

FIG. 2 illustrates the bar graph showing the comparison of maize plant growth under different test conditions, according to an embodiment of the present invention.

FIG. 3 illustrates the graph showing the comparison of maize plant growth under different test conditions, according to an embodiment of the present invention.

### DETAILED DESCRIPTION OF THE INVENTION

The embodiments of the invention will now be described herein, with reference to the accompanying examples and drawings. It will be understood by those skilled in the art that the foregoing general description and the following detailed description are exemplary and explanatory of the invention and are not intended to be restrictive thereof.

The present invention provides a water retention polymer capable of retaining water for long durations and in huge amounts. The water retention polymer has good biocompatibility, biodegradability, mechanical strength and is capable of retaining water for long durations and in huge amounts.

Further, the present invention provides a method for preparing water retention polymer that is cost effective, easy to perform and environment friendly.

According to an embodiment of the present invention, the water retention polymer includes a bio-waste material, a crosslinker and a polysaccharide.

Further, the bio-waste includes either or a combination of, but not limited to, fruit-waste, vegetable waste, fig barks and oil cake residue. Furthermore, the said fruit waste includes either or a combination of, but not limited to, citrus fruits peels, lemon peels, banana peels and jackfruit peels. The polysaccharides used to prepare water retention polymer and crosslinked with pectin are natural polysaccharides include either or a combination of, but not limited to, linseed gum, cellulose, cellulose derivatives, xanthan gum, gum arabic, guar gum, tragacanth gum, acacia gum, alginic acid and hyaluronic acid. The said crosslinkers used for crosslinking pectin and polysaccharides are, but not limited to, sulfosuccinic acid. The sulfosuccinic acid is a highly efficient cross linker, is non-carcinogenic, non-toxic and readily biodegradable making the environment friendly.

According to an embodiment of the present invention, the polymer is eco-friendly, pollution free and completely degradable as it is made up of all organic ingredients which are easily degradable individually and the polymer is composed entirely of organic components that are easily decomposable even when it is combined as a polymer. These ingredients do not harm, leave residues or pollute the soil or air upon degradation. Upon degradation the water retention polymer provides some nutrients; micro and macronutrients to the soil and plants and acts as organic fertilizer lessening the requirement of other fertilizers by 40-60% for the growth of crop plants.

The water retention polymer minimizes the water requirement by 60-80% and hence is very useful for saving water. Such saved water can be further used for other various purposes and for irrigating the land left un-cultivated due to scarcity of water.

The water retention polymer is effective even on barren lands and on marble slurry and hence can be a solution for using such land pieces that have been left barren or where marble slurry has been dumped upon making it infertile.

Further, the reduction in water requirement of 40-80% in turn lessens the production costs for farmers. This low production cost in turn increases the income generated by the agriculture sector.

Furthermore, the said water retention polymer is capable of holding water for 15-21 days with water absorbing capacity of 60-80%. The eco-friendly polymer increases the plant growth by 100-300% by providing nutrients while degrading and the said polymer is reusable up to 6 months.

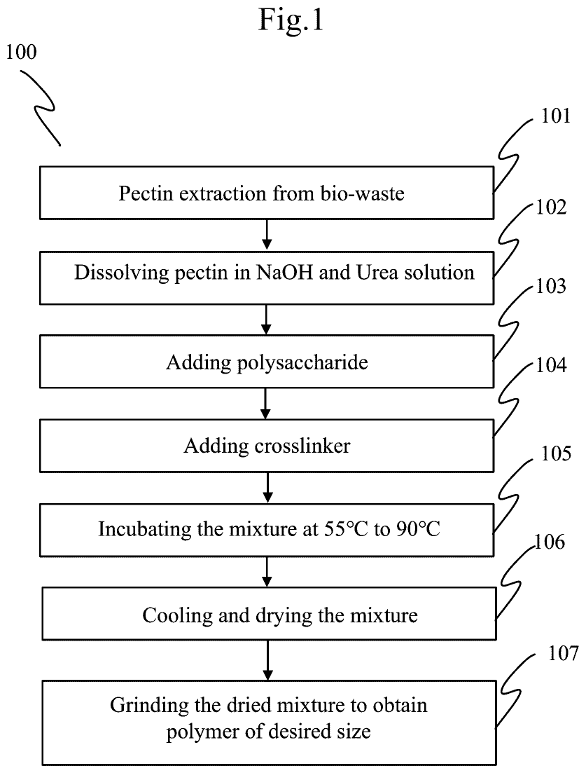

According to another embodiment of the present invention, as shown in FIG. 1, the method 100 begins at step 101, wherein pectin is extracted from bio-waste including the fruit waste. At step 102, the pectin powder obtained at step 101 is dissolved in 6% NaOH and 12% urea mass concentration solution and stirred for 10-15 minutes. At step 103, a linseed gum powder is added to the mixture of step 102 in a ratio of 1:3 to 3:1 with constant stirring for 30 minutes. At step 104, crosslinker sulfosuccinic acid 1-10% of the total weight of polysaccharides polymer is added, and at step 105, incubated at 55° C. to 90° C. for 6 hours. At step 106, the reaction mixture is cooled and dried at 60° C.-80° C. for 24 hours. At step 107, the dried mixture obtained at step 106 is ground to powdered particles to obtain the water retention polymer.

Furthermore, in the preparation method of water retention polymer, the aqueous solution of NaOH is 3%-8% and of urea solution is 3%-10%. The pectin powder is dissolved in NaOH and urea solution for 10-45 minutes with constant stirring at 100 rpm-500 rpm. The powdered particles of water retention polymer are of the mesh size of 60-150.

Further, the bio-waste in the said method includes either or a combination of, but not limited to, fruit-waste, vegetable waste, fig barks and oil cake residue. Furthermore, the said fruit waste includes either or a combination of, but not limited to, citrus fruits peels, lemon peels, banana peels and jackfruit peels. The polysaccharides used to prepare water retention polymer and crosslinked with pectin are natural polysaccharides include either or a combination of, but not limited to, linseed gum, cellulose, cellulose derivatives, xanthan gum, arabic gum, guar gum, tragacanth gum, acacia gum, alginic acid and hyaluronic acid. The said crosslinkers used for crosslinking pectin and polysaccharides are, but not limited to, sulfosuccinic acid. The sulfosuccinic acid is highly efficient cross linker, is non-carcinogenic, non-toxic and readily biodegradable making the environment friendly.

The use of fruit waste to prepare water retention polymer basically solves two problems. One is the processing where fruit waste is taken care of and second is the generation of a natural, environmentally friendly, cost effective, sustainable and highly efficient water retention polymer that is helpful for growth of crops and to farmers.

According to an embodiment of the present invention, the pectin is extracted from the fruit peels collected from various generation sites such as juice shops, food processing sites. The collected waste is then cleaned and any extraneous material such as leaves, sticks is removed. The peels are washed with tap water followed by being washed with double distilled water to remove any physical impurity on the surface. The waste is then dried at a temperature below 60° C. for 24-48 hours until constant weight is obtained. The dried material is then ground and sieved using a sieve of mesh size 60-80.The powder thus obtained is mixed with water in a ratio of 1:50 and pH of the water solution is maintained at 1-4 using lemon juice. The mixture is heated at 55° C. for 3 hours and then is cooled for further processing. A soluble pectin and an insoluble pectin are separated from the mixture using cheesecloth. The soluble pectin is then precipitated using equal ratio of ethanol to soluble pectin. The ethanol is added while constantly stirring the mixture. The mixture with ethanol is then left for 30 minutes to allow the pectin to float on the surface. The mixture is then centrifuged to remove water and ethanol. The pectin thus obtained is dried and stored in powdered form for further use.

The pectin used in the preparation of water retention polymer preferably contains galacturonic acid content of above 75%, methoxy content of 9-15%, degree of esterification below 50%, which provides a structure useful to retain water. The degree of esterification of 20%-25% provides a structure more useful to retain water.

### EXAMPLES

In an embodiment of the present invention, water retention polymer was tested for its water retaining ability. The experiment was performed at 21° C. and humidity was maintained at 60% using a humidifier. For the experiment 5 g of starch based, 5 g of pectin based, 5 g acrylic based and three orange peel-based variables were placed in six separate vessels. To each vessel 200 ml of distilled water was added and allowed to rest for 10 minutes. The water retention ability of the six polymers was calculated using the formula

$$\frac{( gs - gi )}{gi}$$

Where gs: is the weight of the swollen sample and gi: is the initial weight or net weight of the sample. It was observed that orange peel-based polymers displayed the strongest water retaining abilities of 76.1%, the acrylic SAP displayed a water absorbing ability of 74.7% and pectin and starch had ability below 70%.

In another embodiment of the present invention, seven planting containers were filled with 1 kg topsoil and to each container different sample to be tested was added. Samples added were 25 g starch SAP, 25 g pectin SAP, 25 g acrylic SAP and these three samples were considered as positive control for the experiment. The 25 g orange peel powder, 25 g orange peel solution and 25 g orange peel mixture served as experimental group and container without any sample served as a reference. Each of the sample added were mixed well with the soil and were saturated with 100 ml water on day 0.For the next 21 days no additional water was added to the containers. Soil moisture was then measured at specific times each day for 21 days using soil moisture meter.

It was observed that containers after 10 days with orange peel variables, acrylic SAP, starch SAP and pectin SAP had significantly greater soil moisture levels compared to the control with no sample. After twenty-one days, the soil moisture in the pots containing the ‘Orange peel powder’, ‘Orange peel mixture’, starch SAP and acrylic SAP remained at moisture levels of 3.8 to 4.8.These moisture levels are plant growth friendly.

In another experiment, the growth of plant was determined. It was observed that the number of flowers was significantly more in the plants given orange peel mixture and acrylic SAP compared to the plant in the container given no sample. Also, the plants were healthier and stronger in the containers containing orange peel mixture as compared to plants in the container containing acrylic SAP. Further, it was also observed that the plants in the container with no sample started to die after day 10 while in other containers containing acrylic SAP and orange peel mixture plants continued to grow healthily until day 16 and started to die only after day 20.

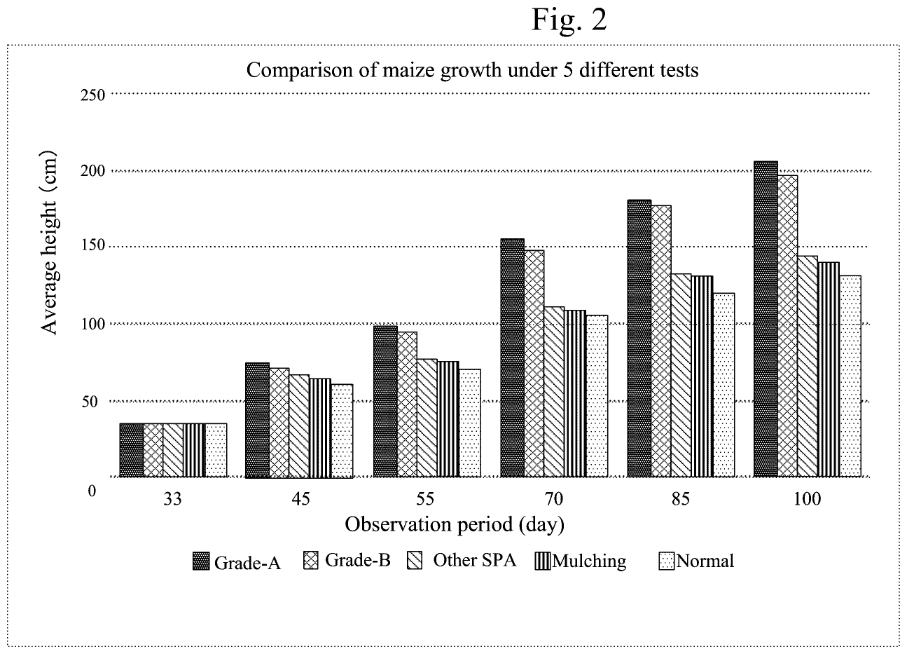

In yet another experiment, the testing of the polymer was done with maize plants in the field. For the experiment, an area of 100 sq ft was chosen and the seeds used were Pratap Pakka-5.The soil type was sandy soil, and the measurements and observations were done for 100 days. The observations of the experiment are tabulated below and represented in bar graph shown as FIG. 2:

| S. | | Average Height (cm) | | | | |
|---|---|---|---|---|---|---|
| no. | Day | Grade-A | Grade-B | Other SAP | Mulching | No sample |
| 1 | 33 | 35 | 35 | 35 | 35 | 35 |
| 2 | 45 | 74 | 70 | 65 | 64.5 | 60 |
| 3 | 55 | 98 | 93 | 77 | 75 | 70 |
| 4 | 70 | 155 | 148 | 110 | 108 | 105 |
| 5 | 85 | 180 | 178 | 131.5 | 130.5 | 120 |
| 6 | 100 | 206 | 197 | 144.5 | 140 | 130.5 |

Where Grade A in Table 1 refers to a high-purity pectin product, with a pectin content ranging from 90% to 95%. Grade B in Table 1 denotes a lower-purity pectin, with a pectin content between 70% and 78%. Other SAP in Table 1 includes super absorbent polymers synthesized using acrylic acid or acrylamide as monomers. The term, “Mulching” means to cover base or roots of plant or tree with soil around the base or roots. Mulching is conducted to control transpiration of water in the soil or to prevent temperature-rising effect of soil or weed growth. The term, “S. no.” indicates a sample number, and for example, “day 33” indicates that 33 days have passed since the start of the experiment.

The experiment was conducted with 8 maize plants and the plants were irrigated only twice. It was observed that the maximum growth of plants was in the set given Grade A followed by others as shown below: Grade-A>Grade-B>Other SAP>Mulching>Normal Case;

The water retention power observed was: Other SAP>Grade-A>Grade-B>Mulching>Normal Case;

Stem Diameter was: Stem dia.: Grade-A>Grade-B>Other SAP>Mulching>Normal Case; and

Average Number of leaves per plant was the highest in the case of Grade-A: Grade-A>Grade-B>Other SAP>Mulching>Normal Case. Wherein “Normal case” means “No sample” in Table 1.That is, “Normal case” means “No Plant”.

In yet another experiment, the effect of water absorbency with polysaccharides and crosslinker in various ratios were observed. Table 2 shows the results obtained.

| S. | | Pectin | Linseed | SA 1 | SA3 | SA6 | SA9 | Water |
|---|---|---|---|---|---|---|---|---|
| No | Nomenclature | (g) | gum (g) | % (g) | % (g) | % (g) | % (g) | Absorption (ml/g) |
| 1 | PLSA100/0/0 | 1 | 0 | 0 | 0 | 0 | 0 | 7.2 |
| 2 | PLSA0/100/0 | 0 | 1 | 0 | 0 | 0 | 0 | 18 |
| 3 | PLSA90/10/1 | 0.9 | 0.1 | 0.1 | 0 | 0 | 0 | 21 |
| 4 | PLSA90/10/3 | 0.9 | 0.1 | 0 | 0.3 | 0 | 0 | 43 |
| 5 | PLSA90/10/6 | 0.9 | 0.1 | 0 | 0 | 0.6 | 0 | 30 |
| 6 | PLSA90/10/9 | 0.9 | 0.1 | 0 | 0 | 0 | 0.9 | 27 |
| 7 | PLSA75/25/3 | 0.75 | 0.25 | 0 | 0.3 | 0 | 0 | 86 |
| 8 | PLSA25/75/3 | 0.25 | 0.75 | 0 | 0.3 | 0 | 0 | 59 |
| 9 | PLSA50/50/3 | 0.50 | 0.50 | 0 | 0.3 | 0 | 0 | 63 |
| 10 | PLSA50/50/6 | 0.50 | 0.50 | 0 | 0 | 0.6 | 0 | 57 |
| 11 | PLSA58/42/6 | 0.58 | 0.42 | 0 | 0 | 0.6 | 0 | 89 |
| 12 | PLSA75/25/6 | 0.75 | 0.25 | 0 | 0 | 0.6 | 0 | 85 |

In Table 2, PLSA represents the weight ratio of pectin, linseed gum, and SA. PLSA 90/10/1 in sample 3 means 0.9 g of pectin, 0.1 g of linseed gum, and 0.01 g of SA. PLSA 75/25/3 in sample 7 means 0.75 g of pectin, 0.25 g of linseed gum, and 0.03 g of SA. PLSA58/42/6 in sample 11 represents 0.58 g of pectin, 0.42 g of linseed gum, and 0.06 g of SA. Other samples also represent the mixtures in terms of weight ratios.

In Table 2, samples 1 and 2 are positive controls, samples 3-6 are comparative examples, and samples 7-12 are examples (test group). Only in the samples with a pectin content of 0.58 g or more, the water supply exceeded 85%, indicating that a certain amount of pectin is required to improve the water supply.

In yet another experiment, a plant condition and a water content of the soil were further observed. The soil moisture was measured at specific times each day for 21 days through almost the same procedure as described above. The water content of soil in each container is shown in Table 3.The condition of each plant in each container is shown in Table 4.

TABLE 3
Water content of soil in each container (%)

| | | | | | T2 | T3 | T4 |
|---|---|---|---|---|---|---|---|
| | C | P1 | P2 | T1 | Orange | Orange | Orange Peel |
| | Negative | Starch | Acryl | Pectin | Peel | Peel | Powder + |
| Day | Control | SAP | SAP | SAP | Powder | Solution | Solution |
| 0 | 100 | 100 | 100 | 100 | 100 | 100 | 100 |
| 2 | 88 | 96 | 94 | 98 | 92 | 91 | 92 |
| 4 | 78 | 92 | 88 | 96 | 85 | 83 | 85 |
| 6 | 70 | 87 | 81 | 94 | 78 | 76 | 78 |
| 8 | 62 | 82 | 74 | 92 | 71 | 70 | 72 |
| 10 | 55 | 77 | 68 | 90 | 64 | 63 | 65 |
| 12 | 49 | 74 | 65 | 89 | 58 | 57 | 59 |
| 14 | 43 | 65 | 56 | 86 | 52 | 51 | 53 |
| 16 | 37 | 59 | 50 | 84 | 46 | 45 | 47 |
| 18 | 31 | 53 | 44 | 82 | 41 | 39 | 42 |
| 20 | 25 | 47 | 38 | 80 | 36 | 34 | 37 |
| 21 | 22 | 44 | 35 | 79 | 34 | 32 | 35 |

TABLE 4

| | Condition of plant in each container | | | | | | |
|---|---|---|---|---|---|---|---|
| | | | | | T2 | T3 | T4 |
| | C | P1 | P2 | T1 | Orange | Orange | Orenge Peel |
| | Negative | Starch | Acryl | Pectin | Peel | Peel | Powder + |
| Day | Control | SAP | SAP | SAP | Powder | Solution | Solution |
| 0 | Seeded | Seeded | Seeded | Seeded | Seeded | Seeded | Seeded |
| 2 | Weak | No sprout | No sprout | Sprouting | Slight | Slight | Slight |
| | sprouting | | | | sprouting | sprouting | sprouting |
| 4 | Stress | Dormant | Dormant | Healthy | Growing | Growing | Growing |
| | showing | | | sprout | slowly | slowly | slowly |
| 6 | Wilting | 87% No | Stunted | Good | Active | Mild | Mild growth |
| | begins | growth | growth | growth | growth | growth | |
| 8 | Wilting | No | Little | Strong | Slowing | Slowing | Slowing |
| | worsens | develop- | change | foliage | growth | growth | growth |
| | | ment | | | | | |
| 10 | Plants | Dormant | Yellowing | Lush | Slight | Slight | Slight wilting |
| | wilting | | begins | growth | wilting | wilting | |
| 12 | Drying | Dry tips | Dry | Full | Wilting | Wilting | Wilting visible |
| | leaves | | patches | canopy | visible | visible | |
| | | | | forming | | | |
| 14 | Failing | Browning | Poor | Healthy + | Severe | Severe | Severe wilting |
| | plant | | health | stable | wilting | wilting | |
| 16 | Almost | Weak/ | Dying | Thriving | Leaves | Leaves | Leaves |
| | dead | dying | plants | growth | dropping | yellowed | yellowed |
| 18 | Dead | No | Plant | Foliage | Poor | Poor | Poor condition |
| | | recovery | failure | intact | condition | condition | |
| 20 | Fully | Only | Lifeless | Very | Dried out | Dried out | Dried out |
| | dried | stems left | | healthy | | | |
| 21 | Bone dry, | Water left | Fully | Lush & | Plants | Plants | Weak/dead |
| | dead | only | dead | green | dead | dead | |

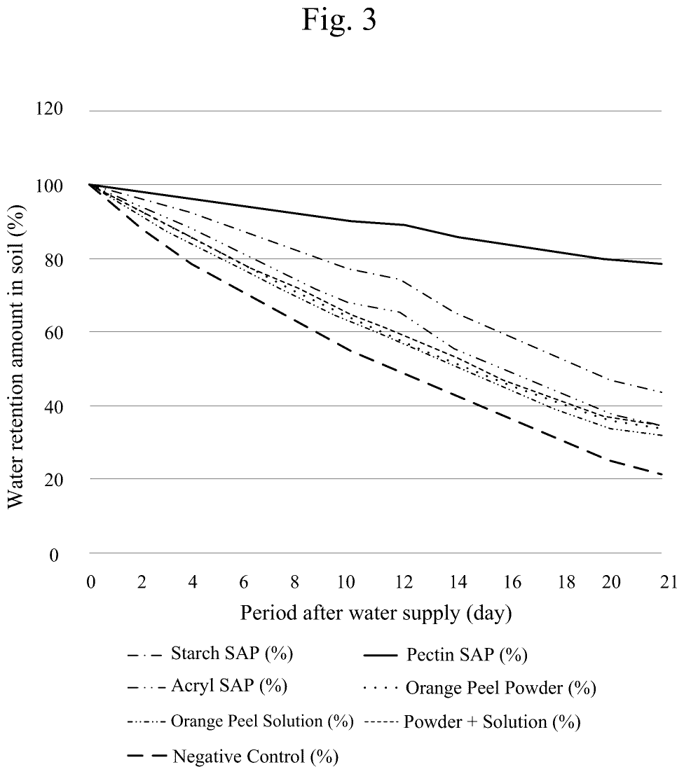

First, experimental results are explained using Table 3 and FIG. 3 that is a line graph of Table 3. In FIG. 3, a horizontal axis shows day(s) after water supply; a vertical axis shows percentage of water retention of soil in each container measured, when the water retention is set 100% in each container on the starting day of the experiment, that is, on day 0.

The water retention rate of Negative Control on day 21 was 22%. In Table 3, day 21 indicates the 21st day after the starting day. Negative Control is abbreviated to as “C.” The water retention rates of P1 and P2 in the positive control group, which are abbreviated as “P,” were respectively 44% and 35% on day 21.The water retention rates of T2 to T4 in the test group, which are abbreviated as “T,” were 35 to 32% on day 21.In contrast, T1, namely Pectin SAP of the present invention, keeps a high retention ratio of about 80% on day 21.

In the container of C, the water retention ratio decreased to about 50% on day 12.In the containers of P1 and P2, the water retention ratio of the soil decreased to about 50% after day 16 to 20. In the containers of T2 to T4, the water retention ratio decreased to about 50% after day 14 or 16.In the container of T1, the water retention ratio kept more than 50% even on day 21.Except for the containers of T1, the water retention ratios in the containers decreased less than 50% on day 21.Table 3 indicates that the amount of decreasing water for C is larger than that of for T1, which leads to the results that T1 reduces the amount of water required for growing a plant by around 80%. For instance, the remaining water content for C is 22% while that for T1 is 79%. The experimental results may lead to the conclusion that T1 reduces the amount of water required for growing a plant by 60-80%.

Next, experimental results are explained using Table 4.On day 2, in the container of T1, healthy sprouting was observed. In contrast, slight sprouting was observed in the containers of T2 to T4, and weak sprouting was observed in the container of C. In the containers of P1 and P2, no sprout was observed. That is, the plants in the containers other than T1 did not grow up sufficiently, and the most of them have died by day 21.The plants except for T1 stopped growing and withered their leaves. In contrast, the plant in container T1 grew steadily, and stayed healthy without any yellowing or falling leaves even on day 21.Also, in the container of T1, 100% of seeds were sprouted on day 2.

It is clarified that the amount of water content is quite important for the plants in the container, and that keeping the water retention amount of more than 50% can be necessary for the healthy growth of the plants.

It is also clarified that pectin SAP of the present invention accelerates sprouting of the plants. Further, since pectin SAP of the present invention has high water retaining property, it is further clarified that pectin SAP accelerates the plants and keep the plants healthy even in a period or region having little amount of rainfall.

Accordingly, it is clarified that pectin SAP of the present invention contributes to maintaining the water retention ratio; and it improves both of well sprouting ratio and growth compared to other SAPs.

It will be apparent to those skilled in the art that various modifications and variations can be made in the products and methods of the present invention without departing from the spirit or scope of the invention. Thus, it is intended that the present invention covers the modifications and variations of this invention provided they come within the scope of the appended claims and their equivalents. Additionally, the foregoing examples are appended for the purpose of illustrating the claimed invention 5 only and should not be construed so as to limit the scope of the claimed invention.

This invention is particularly useful in the fields of agriculture and forestry.

1. An eco-friendly water retention natural polymer comprising a fully biodegradable natural polymer having a water retention property to reduce the amount of water required for growing a plant by 60% to 80%, the fully biodegradable natural polymer comprising nutrient components (1) to (3):
(1) at least one polysaccharide selected from the group consisting of linseed gum, xanthan gum, guar gum, and tragacanth gum;
(2) a polysaccharide extracted from biological waste; and
(3) a cross-linker capable of cross-linking the at least one polysaccharide to the polysaccharide derived from biological waste.

2. The eco-friendly water retention natural polymer including the fully biodegradable natural polymer according to claim 1,
wherein the biological waste from which the polysaccharide is extracted is at least one selected from the group consisting of a fruit waste, a vegetable waste, a fig bark, and an oil cake residue; and
wherein the fruit waste is at least one selected from the group consisting of a citrus fruit peel, a banana peel, and a jackfruit skin.

3. The eco-friendly water retention natural polymer including the fully biodegradable natural polymer according to claim 1,
wherein the polysaccharide is pectin having a galacturonic acid content of above 75%, a methoxy content of 9 to 15%, and a degree of esterification below 50%.

4. The eco-friendly water retention natural polymer including the fully biodegradable natural polymer according to the claim 3, wherein the degree of esterification is between below 20 to 25%.

5. The eco-friendly water retention natural polymer including the fully biodegradable natural polymer according to claim 1, wherein the cross-linker is sulfosuccinic acid.

6. The eco-friendly water retention natural polymer including the fully biodegradable natural polymer according to claim 1, wherein the cross-linker is not a metal ion.

7. A production method for preparing an eco-friendly water retention natural polymer including a fully biodegradable natural polymer, the method comprising:
(A) extracting pectin from biological waste;
(B) dissolving the pectin obtained in (A) in a solution comprising 3% to 8% of NaOH and 3% to 10% of urea by stirring at 100 to 500 rpm for 10 to 45 minutes to obtain a pectin solution;
(C) adding at least one polysaccharide selected from the group consisting of linseed gum, xanthan gum, guar gum and tragacanth gum at a ratio of 1:3 to 3:1 by weight to the pectin solution by stirring for 25 to 35 minutes;
(D) adding 1% to 10% of a cross-linking agent by total weight to the polymer, and mixing the cross-linking agent and the pectin solution of (C) to obtain a mixture;
(E) cross-linking the mixture by incubating the mixture at 55 to 90 degrees centigrade for 5 to 6 hours;
(F) cooling the mixture and then drying the mixture for 15 to 24 hours at 60 to 80 degrees centigrade; and
(G) grinding a polymer obtained in (E) to prepare a powder of which a mesh size ranges from 60 to 150.

8. The production method for preparing the eco-friendly water retention natural polymer including the fully biodegradable natural polymer according to claim 7, wherein
the biological waste is at least one selected from the group consisting of a fruit-waste, a vegetable waste, a fig bark and an oil cake residue.

9. The production method for preparing the eco-friendly water retention natural polymer including the fully biodegradable natural polymer according to claim 8, wherein
the fruit-waste is at least one selected from the group consisting of a citrus fruit peel, a banana peel, and a jackfruit skin.

10. The production method for preparing the eco-friendly water retention natural polymer including the fully biodegradable natural polymer according to claim 7, wherein the extracting step further comprises:
(A1) obtaining cleaned waste by washing a fruit peel of the biological-waste with tap water, and then washing the fruit peel with redistilled water to remove physical impurities from a surface of the fruit peel;
(A2) preparing a powder by drying the cleaned waste at a temperature under 60 degrees centigrade for 24 to 48 hours to obtain a dried waste, and then grinding the dried waste to be filtered with a filter having a mesh size from 60 to 80;
(A3) mixing the dried powder with water at the ratio of 1:50 to prepare a mixture, adjusting pH of the mixture between 1 to 4 by using lemon juice, heating the mixture at 55 degrees centigrade for 3 hours, and then cooling the mixture thereby separating soluble pectin from insoluble pectin;
(A4) precipitating the soluble pectin by adding equal volume of ethanol to a separated soluble pectin solution; and
(A5) powdering the soluble pectin by drying the soluble pectin solution obtained in (A4).

11. The production method for preparing the eco-friendly water retention natural polymer including the fully biodegradable natural polymer according to claim 7, wherein
the pectin has galacturonic acid content of above 75%, methoxy content of 9 to 15%, and degree of esterification below 50%.

12. The production method for preparing the eco-friendly water retention natural polymer including the fully biodegradable natural polymer according to claim 11, wherein
the degree of esterification is 20 to 25%.

13. The production method for preparing the eco-friendly water retention natural polymer including the fully biodegradable natural polymer according to claim 7, wherein
the fully biodegradable polymer has water retention property to reduce the amount of water required for growing a plant by 60% to 80%.

14. The production method for preparing the eco-friendly water retention natural polymer including the fully biodegradable natural polymer according to claim 7, wherein the crosslinker is not a metal ion.
